(19) United States
(12) Patent Application Publication
(10) Pub. No.: US 2020/0183306 A1
(43) Pub. Date: Jun. 11, 2020

(54) IMAGE FORMING APPARATUS

(71) Applicant: Konica Minolta, Inc., Tokyo (JP)

(72) Inventor: Taizou OONISHI, Tokyo (JP)

(21) Appl. No.: 16/683,621

(22) Filed: Nov. 14, 2019

(30) Foreign Application Priority Data
Dec. 11, 2018 (JP) 2018-231778

(51) Int. Cl. G03G 15/20

(52) U.S. Cl. CPC G03G 15/2028

(57) ABSTRACT

An image forming apparatus includes: a fusing device having a pad member and a pressure member that works to form a nip region in the interface with the pad member; a contact condition changing mechanism that optimizes the distribution of interfacial pressure in the nip region by changing the contact condition between the pad member and the pressure member, and that changes the contact condition between the pad member and the pressure member by moving either or both of the pad member and the pressure member; an image information sensor that senses image information from a sheet of paper having passed through the nip region; and a processor that makes the contact condition changing mechanism optimize the distribution of interfacial pressure in the nip region with reference to a sensing result obtained by the image information sensor.

The disclosure of Japanese Patent Application No. 2018-231778 filed on Dec. 11, 2018, including description, claims, drawings, and abstract, is incorporated herein by reference in its entirety.

### BACKGROUND

### Technological Field

The present invention relates to an image forming apparatus such as a copier or printer being provided with a fusing device having a pad member and a pressure member that works to form a nip region in the interface with the pad member.

### Description of the Related Art

In a fusing device such as described above, paper jams and image noise can be caused in a nip region formed by the pad member and the pressure member e.g. pressure roller, depending on the contact condition between the members. Most fusing devices, however, are hardly capable of controlling the contact condition between the members because of their complicated pressure welding configurations.

The optimum distribution of interfacial pressure in paper conveyance directions changes depending on paper conditions (such as basis weight, orientation, and environmental humidity). To achieve the optimum distribution of pressure, it is desired that the contact condition between the pad member and the pressure member be adequately controlled.

Japanese Unexamined Patent Application Publication No. 2014-032342 discloses an image forming apparatus having a fusing device being provided with a fusing member and a pressure member that work to form a nip region together; the image forming apparatus is capable of relocating the pressure member away from the fusing member depending on the image information of a toner image, which is sensed by an image information sensor.

Japanese Unexamined Patent Publication No. 2012-510087 discloses a fusing device including a pressure applicator that determines a pressure profile.

Japanese Unexamined Patent Application Publication No. 2017-032953 discloses an image forming apparatus having a fusing device being provided with: a roller and a belt that work to form a nip region together; a pressure pad that presses the belt to the roller; and a holding member that holds the pressure pad; the image forming apparatus is capable of relocating the pressure pad toward the holding member.

Japanese Unexamined Patent Application Publication No. 2011-100050 discloses an image forming apparatus being capable of optimizing the distribution of nip pressure in a rotating direction of a belt member with reference to the type and characteristics of recording materials, when a jam or an uneven sheen occurs.

In Japanese Unexamined Patent Application Publication No. 2014-032342, the image forming apparatus simply relocates the pressure member away from the fusing member, which means the image forming apparatus is not capable of optimizing the distribution of interfacial pressure in the nip region precisely with reference to varying image information of a sheet of paper having passed through the nip region.

In Japanese Unexamined Patent Publication No. 2012-510087, configuration simplicity of the fusing device has to be sacrificed for the pressure applicator, which is unfavorable.

In Japanese Unexamined Patent Application Publications No. 2017-032953 and 2011-100050, the image forming apparatus does not sense image information from a sheet of paper having passed through the nip region, which means the image forming apparatus is not capable of optimizing the distribution of interfacial pressure in the nip region precisely with reference to varying image information of a sheet of paper having passed through the nip region.

### SUMMARY

The present invention, which has been made in consideration of such a technical background as described above, is capable of, without requiring a more complicated configuration in a fusing device, optimizing the distribution of interfacial pressure in a nip region precisely with reference to variegated image information of a sheet of paper having passed through the nip region.

A first aspect of the present invention relates to an image forming apparatus including:

a fusing device having a pad member and a pressure member that works to form a nip region in the interface with the pad member;

a contact condition changing mechanism that optimizes the distribution of interfacial pressure in the nip region by changing the contact condition between the pad member and the pressure member, and that changes the contact condition between the pad member and the pressure member by moving either or both of the pad member and the pressure member;

an image information sensor that senses image information from a sheet of paper having passed through the nip region; and

a processor that makes the contact condition changing mechanism optimize the distribution of interfacial pressure in the nip region with reference to a sensing result obtained by the image information sensor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram illustrating a configuration of an image forming apparatus according to one embodiment of the present invention.

FIG. 2 illustrates a schematic cross section of a fusing device.

FIG. 3A is an enlarged view of a cross section of a pad member and a pressure roller being in contact with each other, when they are cut widthwise; FIG. 3B is an enlarged view of a cross section of the pad member only.

FIG. 4 is a chart showing a distribution of interfacial pressure in a nip region N in paper conveyance directions, when a wavy-patterned sheen is sensed.

FIG. 5 is an enlarged view of a cross section of the pad member and the pressure roller being in contact with each other, for reference in describing an example of how to optimize the distribution of nip pressure when a deformation of paper or a gradation-patterned sheen is sensed.

FIG. 6 is an enlarged view of a cross section of the pad member and the pressure roller being in contact with each other, for reference in describing another example of how to optimize the distribution of nip pressure when a deformation of paper or a gradation-patterned sheen is sensed.

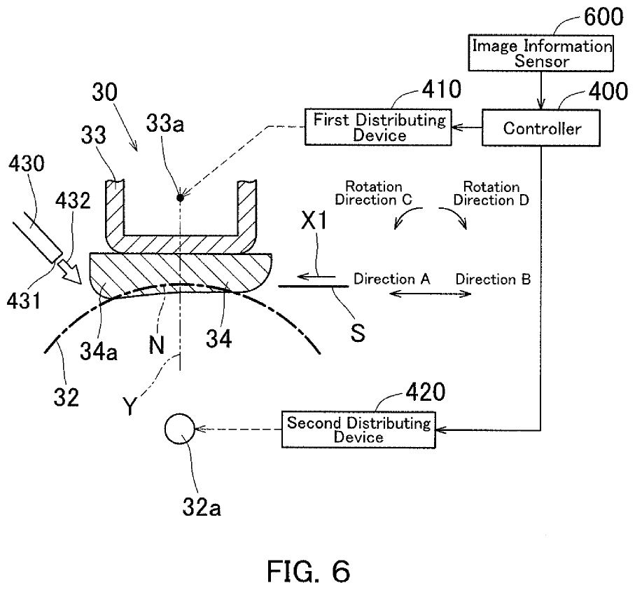

FIG. 7A is a view for reference in describing a wavy-patterned sheen; FIG. 7B is a view for reference in describing a deformation of paper.

### DETAILED DESCRIPTION OF EMBODIMENTS

Hereinafter, one or more embodiments of the present invention will be described with reference to the drawings. However, the scope of the invention is not limited to the disclosed embodiments.

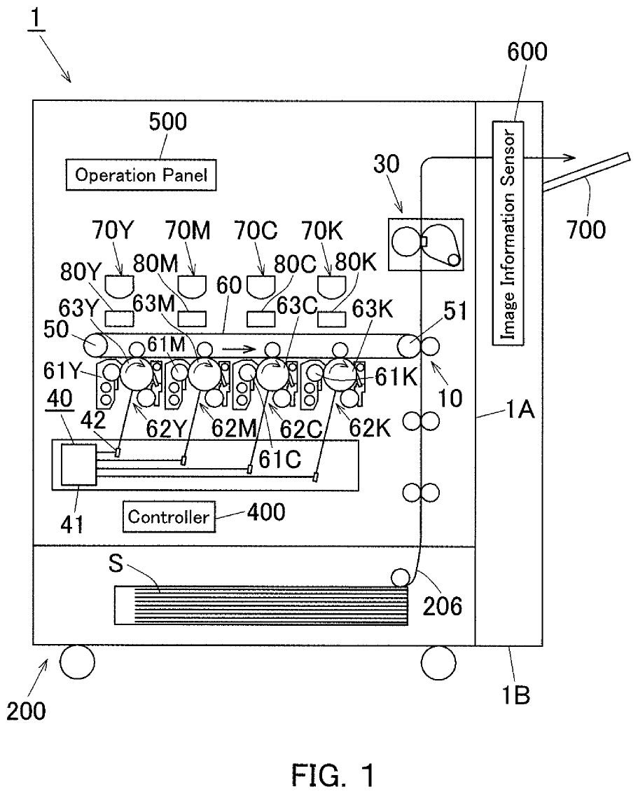

FIG. 1 is a schematic diagram illustrating a configuration of an image forming apparatus 1 according to one embodiment of the present invention. In this embodiment, a tandem color printer is employed as the image forming apparatus 1.

As referred to FIG. 1, the image forming apparatus 1 is provided with a main body 1A and a post-processing section 1B; the main body 1A has a sheet feeder 200 in its lower region and a color imaging device 10 in its middle region. The main body 1A further has a paper conveyance path 206 that is mounted such that a sheet of paper S is conveyed upward after being fed by the sheet feeder 200.

The color imaging device 10 is provided with: rollers 50 and 51 as a pair; an intermediate transfer belt 60; and photoconductor units 62C, 62M, 62Y, and 62K constituting imaging units of yellow (Y), magenta (M), cyan (C), and black (K). The rollers 50 and 51 are disposed nearly at a half height of the main body 1A; the intermediate transfer belt 60 is looped over the rollers 50 and 51 in an elliptic form having two horizontal lines and circulates in a direction indicated by the arrow; the photoconductor units 62Y, 62M, 62C, and 62K are disposed along the length of the intermediate transfer belt 60.

After forming toner images, the photoconductor units 62Y, 62M, 62C, and 62K transfer the toner images one by one onto the intermediate transfer belt 60. When a sheet of paper S reaches the roller 51 (on the right of the belt in this figure) through the paper conveyance path 206, the toner images on the intermediate transfer belt 60 are transferred onto the sheet of paper S as a second transfer process. After that, the sheet of paper S carrying a consolidated toner image is conveyed to the fusing device 30 for a fusing process. Being subjected to a fusing process, the sheet of paper S is conveyed to the post-processing section 1B having an image information sensor 600; and the image information sensor 600 senses image information from the sheet of paper S. The sheet of paper S is then discharged onto a paper output tray 700. The fusing device 30 and the image information sensor 600 will be later described in detail.

The photoconductor units 62Y, 62M, 62C, and 62K, which conduct imaging by the method of electrostatic copying, are provided with: development portion 61Y, 61M, 61C, and 61K; and photosensitive drums 63Y, 63M, 63C, and 63K, respectively. Each photoconductor unit is further provided with an electrifier, a transcriber, and the like. These components are arranged on the periphery of the corresponding photoconductor unit. The main body 1A is further provided with a luminous section 40; the luminous section 40 is essentially provided with: a print head 41 having four laser diodes, four polygon mirrors, and four scanning lenses; and four reflective mirrors 42. While the photosensitive drums 63Y, 63M, 63C, and 63K are charged by the electrifiers, the laser diodes emit light to the surfaces of the photosensitive drums 63Y, 63M, 63C, and 63K to form latent images thereon.

The main body 1A is further provided with: toner cartridges 70Y, 70M, 70C, and 70K; and sub-hoppers 80Y, 80M, 80C, and 80K, which serve as a supply mechanism for supplying toner to the development portions 61Y, 61M, 61C, and 61K of the photoconductor units 62Y, 62M, 62C, and 62K. The toner cartridges 70Y, 70M, 70C, and 70K and the sub-hoppers 80Y, 80M, 80C, and 80K are disposed above the photoconductor units 62Y, 62M, 62C, and 62K.

As referred to FIG. 1, the main body 1A is further provided with a controller 400 that controls the image forming apparatus 1 in a unified and systematic manner; specifically, the controller 400 controls the image forming apparatus 1 such that it can perform image forming or other processing as instructed by the user. More specifically, in this embodiment, the controller 400 controls the fusing device 30 with reference to image information sensed by the image information sensor 600. How the fusing device 30 is controlled will be later described in details. As referred to FIG. 1, the main body 1A is further provided with an operation panel 500 having keys and a display.

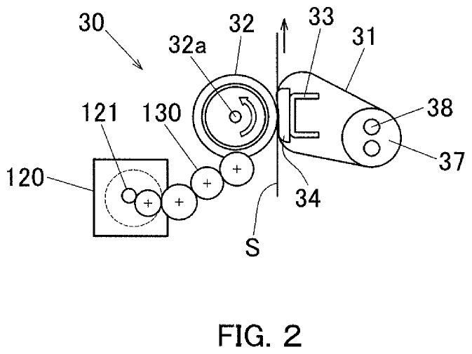

FIG. 2 illustrates a schematic cross section of the fusing device 30. In this embodiment, the fusing device 30 is provided with: a fusing belt 31; a pressure roller 32 (as a pressure member); a holding member 33 having a U-shaped cross section; and a pad member 34 that is entirely mounted on the holding member 33. In this cross section, latitudinal directions of the fusing belt 31 match thickness directions of a sheet of paper; the pressure roller 32 has a certain dimension in thickness directions of a sheet of paper; the holding member 33 has a certain dimension in thickness directions of a sheet of paper; the pad member 34 has a certain dimension in thickness directions of a sheet of paper.

The pad member 34 and the pressure roller 32 are disposed across the fusing belt 31. The fusing belt 31 is looped over a driven roller 37 and the pad member 34 and disposed in the interface between the pad member 34 and the pressure roller 32. As the pressure roller 32 rotates in a direction indicated by the outlined arrow, the fusing belt 31 circulates around the driven roller 37 and the pad member 34. While the fusing belt 31 circulates, a nip region is formed on the fusing belt 31 between the pressure roller 32 and the pad member 34; and a sheet of paper S can be caught at the entry to the nip region and conveyed downstream through the nip region.

The pad member 34, inside the loop of the fusing belt 31, serves to ensure smooth circulation of the fusing belt 31 by reducing friction with the fusing belt 31. To reduce more friction, the main body 1A is further provided with a grease feeder not shown in the figure; the grease feeder applies grease on the inner surface of the loop of the fusing belt 31. Grease on the inner surface allows the fusing belt 31 to slide more smoothly on the pad member 34.

The driven roller 37 has one or more than one thermo lamp 38 inside. The thermo lamp 38 heats the driven roller 37; heat is then conducted to the fusing belt 31 until the temperature of the fusing belt 31 reaches a predetermined temperature. Being exposed to heat and pressure between the pressure roller 32 and the fusing belt 31, a consolidated toner image is firmly attached onto the sheet of paper S.

The main body 1A is further provided with a fusing motor 120 having a driving shaft 121 that is coupled with multiple transmission gears 130; a driving force generated by the fusing motor 120 is transmitted to the pressure roller 32 by way of the transmission gears 130.

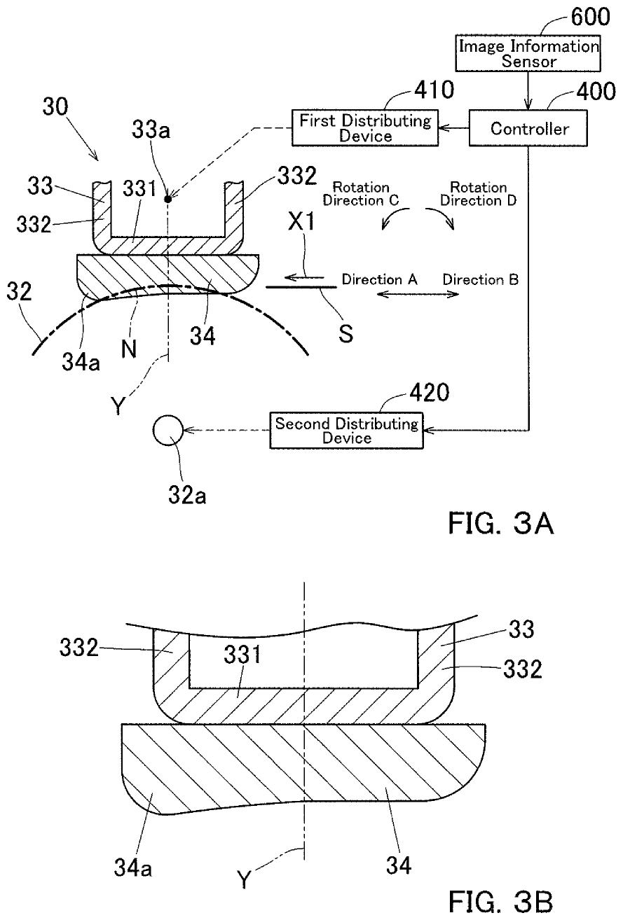

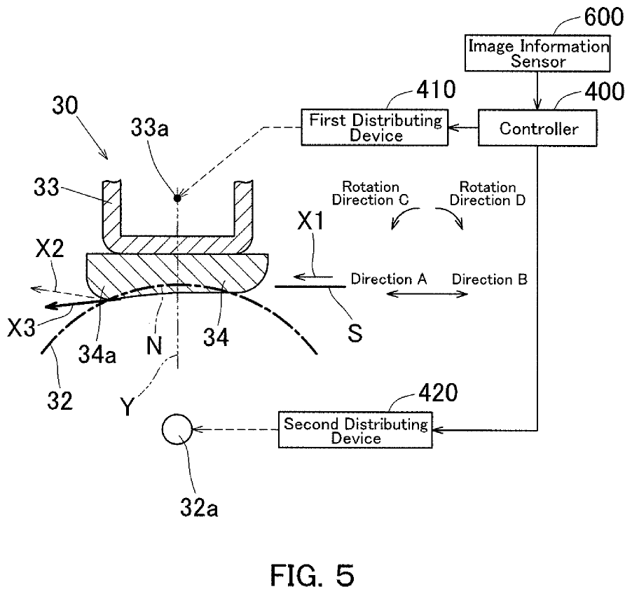

FIG. 3A is an enlarged view of a cross section of the pad member 34 and the pressure roller 32 being in contact with each other, when they are cut widthwise. FIG. 3B is an enlarged view of a cross section of the pad member 34 only. For the sake of simplicity, the fusing belt 31 is omitted and the pressure roller 32 is drawn with a chain line, in FIGS. 3A and 3B, FIG. 5, and the figures following FIG. 5. Furthermore, a sheet of paper S is conveyed in a paper conveyance direction X1 i.e. from right to left in this figure.

The holding member 33 has a U-shaped cross section, as described above, having a flat top 331 and bases 332 that extend at a right angle with respect to the flat top 331 and extend in a longitudinal direction of the holding member 33. The pad member 34 is entirely mounted on an outer surface of the flat top 331 of the holding member 33, which is closer to the pressure roller 32 than an inner surface of the flat top 331 is.

The holding member 33 is configured to travel about a rotation axis 33a to the upstream and downstream side of a paper conveyance direction X1, in other words, in a rotation direction C and a rotation direction D indicated in FIG. 3. The holding member 33 is further configured to slide to the upstream and downstream side of the paper conveyance direction X1, in other words, in a direction A and a direction B indicated in FIG. 3. There is a first distributing device (corresponding to a contact condition changing mechanism) 410 that is configured to switch either or both of (i) between the rotation directions C and D and (ii) between the directions A and B.

Meanwhile, the pressure roller 32 is configured to rotate about a rotation axis 32a under normal conditions. The pressure roller 32 is further configured to slide to the upstream and downstream side of the paper conveyance direction X1, in other words, in the directions A and B indicated in FIG. 3. There is a second distributing device (corresponding to a contact condition changing mechanism) 420 that is configured to switch between the directions A and B.

The pad member 34, which is a flexible sheet material, has an almost flat cross section; technically, the cross section shows a gradual increase in thickness in paper conveyance directions. Specifically, the downstream part 34a of the pad member 34 has a thickness slightly larger than the same of the upstream part. Being exposed to pressure from the pressure roller 32, the pad member 34 slightly deforms; and interfacial pressure between the pressure roller 32 and the pad member 34 causes a nip region N, through which the sheet of paper S will be conveyed. Referring to the cross section of the pad member 34 again, both the upstream and downstream part of the pad member 34 are curved outward.

Upon being subjected to a fusing process, the sheet of paper S is conveyed downstream through the nip region N of the fusing device 30; and the image information sensor 600 senses image information from the sheet of paper S. In this embodiment, the image information sensed from the sheet of paper S (an image on the sheet of paper S is read by scanning) is at least one or all of toner density, reflectivity, and surface roughness. At least one or all of toner density, reflectivity, and surface roughness determine the existence of a wavy-patterned sheen, a gradation-patterned sheen, or a deformation of paper e.g. cockles.

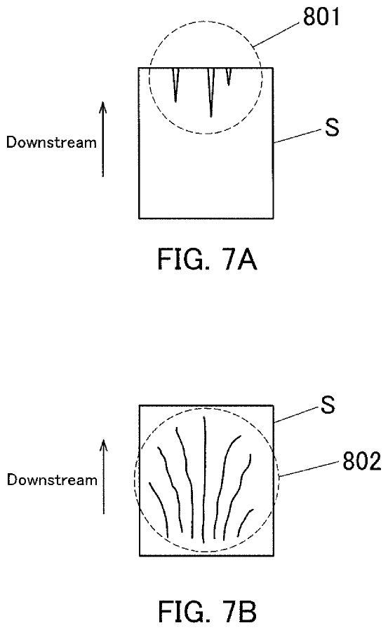

FIG. 7A illustrates an image on the sheet of paper S; a wavy-patterned sheen 801 in this figure is constituted by different levels of reflectivity that look like waves stretching in paper conveyance directions. In contrast, a gradation-patterned sheen is constituted by different levels of reflectivity that look like a seamless gradation; the temperature of the fusing belt 31 is higher in the first rotation than in the second rotation naturally because it is before the sheet of paper S enters the nip region N. FIG. 7B illustrates an image on the sheet of paper S; a deformation 802 in this figure is constituted by cockles, for example, stretching nearly in paper conveyance directions. The methods of sensing toner density, reflectivity, and surface roughness i.e. the methods of sensing a wavy-pattern sheen, a gradation-patterned sheen, and a deformation of paper are publicly known; thus, detailed description thereof will be omitted.

In this embodiment, the downstream part 34a of the pad member 34 has a thickness slightly larger than the same of the upstream part, as described above. Referring to FIG. 3A, the shape allows, under normal conditions, the distribution of interfacial pressure in the nip region N to be asymmetrical with respect to a centerline Y of the nip region N, stretching in paper conveyance directions; in other words, the shape serves to apply more interfacial pressure, in paper conveyance directions, downstream than upstream of the middle of the nip region N. The distribution of interfacial pressure is a key to make a fusing process, including catching the sheet of paper S at the entry to the nip region N and conveying it downstream through the nip region N, successful.

However, the optimum distribution of interfacial pressure in paper conveyance directions changes depending on paper conditions (such as basis weight, orientation, and environmental humidity); a failure in the distribution of interfacial pressure can cause a wavy-patterned sheen, a gradation-patterned sheen, or a deformation of paper.

To solve a solution to this problem, in this embodiment, the image information sensor 600 senses image information from the sheet of paper S having passed through the nip region N. When a wavy-patterned sheen, a gradation-patterned sheen, or a deformation of paper is sensed, the controller 400 makes the first distributing device 410 and/or the second distributing device 420 optimize the distribution of interfacial pressure in the nip region N by changing the contact condition between the pad member 34 and the pressure roller 32. Specifically, the controller 400 performs at least one of: (i) making the pad member 34 travel about its rotation axis; (ii) relocating the pad member 34 in a paper conveyance direction; and (iii) relocating the pressure roller 32 in a paper conveyance direction. Hereinafter, some operation examples will be described in details.

[Operation Example to Solve a Wavy-Patterned Sheen]

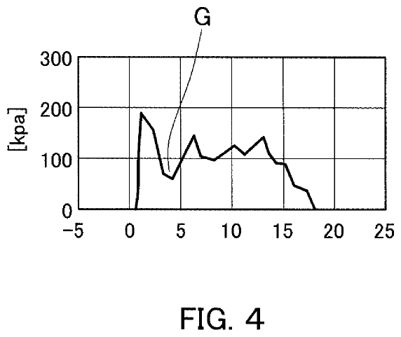

FIG. 4 is a chart showing a distribution of interfacial pressure in the nip region N in paper conveyance directions, when a wavy-patterned sheen is sensed. In this chart, an x-axis indicates paper conveyance directions and that the sheet of paper S is conveyed from right to left in FIG. 4; a y-axis indicates the level of interfacial pressure.

As shown in FIG. 4, there is a large drop point G in interfacial pressure in the left part of the chart, which is a general cause of a wavy-patterned sheen.

When the image information sensor 600 senses a wavy-patterned sheen, the controller 400 makes the first distributing device 410 move the pad member 34 and/or makes the second distributing device 420 move the pressure roller 32, allowing elimination of the large drop point G.

For example, moving the pad member 34 is making the pad member 34 travel in the rotation direction C by a predetermined rotation angle or relocating the pad member 34 in the direction B by a predetermined distance. Moving the pressure roller 32 is relocating the pressure roller 32 in the direction A by a predetermined distance. In other words, one of the following or a combination of two of the following may be performed: (i) making the pad member 34 travel in the rotation direction C; (ii) relocating the pad member 34 in the direction B; and (iii) relocating the pressure roller 32 in the direction A. By this operation, more interfacial pressure will be applied, in paper conveyance directions, about the middle of the nip region N than upstream and downstream of it, and the large drop point G in the left part of the chart will be eliminated; a wavy-patterned sheen can be thus prevented.

[Operation Example to Solve a Deformation of Paper (Cockles)]

When the image information sensor 600 senses a deformation of paper such as cockles, the controller 400 makes the first distributing device 410 move the pad member 34 and/or makes the second distributing device 420 move the pressure roller 32 such that less pressure is applied at the exit from the nip region N. In other words, it is desired that the sheet of paper S, carrying a toner image on one of the surfaces closer to the pad member 34 than the other surface is, be bent at the exit from the nip region N and conveyed in an exit direction X3 indicated by a solid line in FIG. 5, not in an original exit direction X2 indicated by a dashed line. The exit direction X3 is closer to the pressure roller 32 than the original exit direction X2.

For example, moving the pad member 34 is making the pad member 34 travel in the rotation direction D by a predetermined rotation angle or relocating the pad member 34 in the direction A by a predetermined distance. Moving the pressure roller 32 is relocating the pressure roller 32 in the direction B by a predetermined distance. In other words, one of the following or a combination of two of the following may be performed: (i) making the pad member 34 travel in the rotation direction D; (ii) relocating the pad member 34 in the direction A; and (iii) relocating the pressure roller 32 in the direction B. By this operation, the distribution of interfacial pressure in paper conveyance directions will be optimized; a deformation of paper can be thus prevented. Specifically, in this case, the sheet of paper S is bent away from the fusing belt 31 at the exit from the nip region N, and thereby the sheet of paper S is exposed to less heat from the fusing belt 31.

[Operation Example to Solve a Gradation-Patterned Sheen]

As described above, a gradation-patterned sheen is constituted by different levels of reflectivity that look like a seamless gradation; the temperature of the fusing belt 31 is higher in the first rotation than in the second rotation naturally because it is before the sheet of paper S enters the nip region N.

When the image information sensor 600 senses a gradation-patterned sheen, as in a similar manner to a case with a deformation of paper, the controller 400 makes the first distributing device 410 move the pad member 34 and/or makes the second distributing device 420 move the pressure roller 32 such that less pressure is applied at the exit from the nip region N. In other words, it is desired that the sheet of paper S, carrying a toner image on one of the surfaces closer to the pad member 34 than the other surface is, be bent at the exit from the nip region N and conveyed in the exit direction X3 indicated by a solid line in FIG. 5, not in the original exit direction X2 indicated by a dashed line. The exit direction X3 is closer to the pressure roller 32 than the original exit direction X2.

For example, moving the pad member 34 is making the pad member 34 travel in the rotation direction D by a predetermined rotation angle or relocating the pad member 34 in the direction A by a predetermined distance. Moving the pressure roller 32 is relocating the pressure roller 32 in the direction B by a predetermined distance. Similar to a case with a deformation of paper, one of the following or a combination of two of the following may be performed: (i) making the pad member 34 travel in the rotation direction D; (ii) relocating the pad member 34 in the direction A; and (iii) relocating the pressure roller 32 in the direction B. By this operation, the distribution of interfacial pressure in paper conveyance directions will be optimized; a gradation-patterned sheen can be thus prevented. Similar to a case with a deformation of paper, in this case, the sheet of paper S is bent away from the fusing belt 31 at the exit from the nip region N, and thereby the sheet of paper S is exposed to less heat from the fusing belt 31.

[Another Operation Example to Solve a Deformation of Paper (Cockles) or a Gradation-Patterned Sheen]

In this operation example, the image forming apparatus 1 must be further provided with an air-blowing mechanism 430 that is installed downstream of the nip region N of the fusing device 30.

Specifically, the air-blowing mechanism 430 is configured to blow high-pressure air 432 from an air output 431 onto the sheet of paper S at the exit from the nip region N, and the controller 400 is further configured to make the air-blowing mechanism 430 immediately separate the sheet of paper S from the fusing belt 31 by blowing air.

When a deformation of paper or a gradation-patterned sheen is sensed, the controller 400 makes the first distributing device 410 move the pad member 34 and/or makes the second distributing device 420 move the pressure roller 32 such that less pressure is applied at the exit from the nip region N. In other words, it is desired that the sheet of paper S be conveyed in the exit direction X3 indicated by a solid line in FIG. 5, not in the original exit direction X2 indicated by a dashed line. The exit direction X3 is closer to the pressure roller 32 than the exit direction X2. As in the above-described cases, moving the pad member 34 is making the pad member 34 travel in the rotation direction D by a predetermined rotation angle or relocating the pad member 34 in the direction A by a predetermined distance; and moving the pressure roller 32 is relocating the pressure roller 32 in the direction B by a predetermined distance.

Furthermore, the controller 400 makes the air-blowing mechanism 430 blow air from the air output 431 and convey the sheet of paper S in a direction closer to the pressure roller 32 than the exit direction X3. In other words, in this case, the sheet of paper S is bent further away from the fusing belt 31 at the exit from the nip region N, and thereby the sheet of paper S is exposed to ever less heat from the fusing belt 31. By this operation, a deformation of paper or a gradation-patterned sheen can be prevented. In addition, the surface temperature of the fusing belt 31 is lowered with air from the air outlet 431; accordingly, the surface temperature difference before and after the sheet of paper S enters the nip region N becomes smaller. By this operation, a gradation-patterned sheen can be prevented as well.

While one embodiment of the present invention has been described in details herein it should be understood that the present invention is not limited to the foregoing embodiment. For example, in this embodiment, the pad member 34 is configured to travel about its rotation axis in the rotation directions C and D and slide in the directions A and B, and the pressure roller 32 is configured to slide in the directions A and B. The directions A, B, C, and D should not be limited to those described in this embodiment, and alternatively may be oblique with respect to paper conveyance directions. In other words, the directions of movement should be determined substantially such that the contact condition between the pad member 34 and the pressure roller 32 can be changed and thereby the distribution of interfacial pressure in the nip region N can be optimized.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a fusing device having a pad member and a pressure member that works to form a nip region in the interface with the pad member;
a contact condition changing mechanism that optimizes the distribution of interfacial pressure in the nip region by changing the contact condition between the pad member and the pressure member, and that changes the contact condition between the pad member and the pressure member by moving either or both of the pad member and the pressure member;
an image information sensor that senses image information from a sheet of paper having passed through the nip region; and
a processor that makes the contact condition changing mechanism optimize the distribution of interfacial pressure in the nip region with reference to a sensing result obtained by the image information sensor.

2. The image forming apparatus according to claim 1, wherein optimizing the distribution of interfacial pressure in the nip region is optimizing the distribution of pressure in paper conveyance directions.

3. The image forming apparatus according to claim 1, wherein the pad member has a shape allowing the distribution of interfacial pressure in the nip region to be asymmetrical in paper conveyance directions between upstream and downstream of the middle of the nip region.

4. The image forming system according to claim 1, wherein the contact condition changing mechanism changes the contact condition between the pad member and the pressure member by either or both of (i) relocating the pad member in a paper conveyance direction and (ii) making the pad member travel about a rotation axis of the pad member.

5. The data processing system according to claim 1, wherein the contact condition changing mechanism changes the contact condition between the pad member and the pressure member by relocating the pressure member in a paper conveyance direction.

6. The image processing apparatus according claim 1, wherein the image information sensed by the image information sensor is at least one of a wavy-patterned sheen, a deformation of paper, and a gradation-patterned sheen.

7. The image forming apparatus according to claim 1, wherein the image information sensed by the image information sensor is at least one or all of toner density, reflectivity, and surface roughness.

8. The image forming apparatus according to claim 1, wherein, when the image information sensor senses a wavy-patterned sheen, the processor makes the contact condition changing mechanism apply more interfacial pressure, in paper conveyance directions, about the middle of the nip region than upstream and downstream of it.

9. The image forming apparatus according to claim 1, wherein, when the image information sensor senses either or both of a deformation of paper and a gradation-patterned sheen, the processor makes the contact condition changing mechanism bend the sheet of paper away from the pad member at an exit from the nip region, the sheet of paper carrying a toner image on one surface thereof, the one surface being closer to the pad member than another surface thereof is.

10. The image forming system according to claim 9, further comprising an air-blowing mechanism that immediately separates the sheet of paper from the fusing device by blowing air onto the sheet of paper at the exit from the nip region, wherein, when the image information sensor senses either or both of a deformation of paper and a gradation-patterned sheen, the processor makes the air-blowing mechanism blow more air.
